(19) United States
(12) Patent Application Publication
(10) Pub. No.: US 2025/0278245 A1
(43) Pub. Date: Sep. 4, 2025

(54) MULTIPLY-ACCUMULATE UNIT INPUT MAPPING

(71) Applicant: Micron Technology, Inc., Boise, ID (US)

(72) Inventors: Xinyu Wu, Boise, ID (US); Troy A. Manning, Meridian, ID (US); Glen E. Hush, Boise, ID (US); Peter L. Brown, Eagle, ID (US); Troy D. Larsen, Meridian, ID (US); Timothy P. Finkbeiner, Boise, ID (US)

(21) Appl. No.: 19/045,298

(22) Filed: Feb. 4, 2025

Related U.S. Application Data
(60) Provisional application No. 63/560,922, filed on Mar. 4, 2024.

(51) Int. Cl. G06F 7/544

(52) U.S. Cl. CPC G06F 7/5443

(57) ABSTRACT

The PU of a memory device can receive a matrix of data values and a vector of data values stored in the bank. The PU can perform a first plurality of multiplication operations on a first data value of the vector utilizing a first plurality of data values of a first column of the matrix. The first plurality of multiplication operations can be performed by a plurality of multiply-accumulate (MAC) units. Each of the first plurality of multiplication operations can be performed by a different MAC unit of the plurality of MAC units. The PU can perform a second plurality of multiplication operations on a second data value of the vector utilizing a second plurality of data values of a second column of the matrix. Each of the second plurality of multiplication operations can be performed by a different MAC unit of the plurality of MAC units.

### PRIORITY INFORMATION

This application claims the benefit of U.S. Provisional Application No. 63/560,922, filed on Mar. 4, 2024, the contents of which are incorporated herein by reference.

### TECHNICAL FIELD

The present disclosure relates generally to memory, and more particularly to apparatuses and methods associated with mapping inputs to multiply-accumulate (MAC) units.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory system in accordance with a number of embodiments of the present disclosure.

FIG. 2 is a block diagram of a memory device including a processing unit in accordance with a number of embodiments of the present disclosure.

FIG. 3A is a block diagram of a multiply-accumulate unit in accordance with a number of embodiments of the present disclosure.

FIG. 3B is a block diagram of a table for mapping in accordance with a number of embodiments of the present disclosure.

FIG. 4 illustrates an example flow diagram of a method for mapping an input to a multiply-accumulate unit in accordance with a number of embodiments of the present disclosure.

FIG. 5 illustrates an example machine of a computer system within which a set of instructions, for causing the machine to perform any one or more of the methodologies discussed herein, can be executed.

### DETAILED DESCRIPTION

The present disclosure includes apparatuses and methods related to mapping inputs to multiply-accumulate (MAC) units. A MAC unit can receive, from an array of memory cells, a first input indicative of first data of a first amount (e.g., a first 8-bit input). The MAC unit can receive, from the array, a second input indicative of second data of the first amount (e.g., a second 8-bit input, different than the first 8-bit input). The MAC unit can divide the first data into a first plurality of bits and a second plurality of bits each of a second amount (e.g., divide the first 8-bit input into a first 4 bits and a second 4 bits). The MAC unit can map the first plurality of bits to a third plurality of bits of the first amount (e.g., map the first 4 bits to an 8-bit data value). The MAC unit can perform a multiplication operation utilizing the third plurality of bits and the second data.

In previous approaches, a MAC unit may be limited by the inputs received by the MAC unit. For example, a MAC unit may receive two 8-bit inputs. The MAC unit may be limited to performing a multiplication operation utilizing the two 8-bit inputs. Having to utilize the inputs of a specific amount (e.g., size of the input such as an 8-bit input) to perform multiplication operations in the MAC units may limit the versatility of the MAC unit.

In order to address these and other deficiencies of current approaches, embodiments of the present disclosure allow for a MAC unit to utilize inputs of multiple amounts (e.g., sizes) to perform multiplication operations. For example, a MAC unit can be utilized to perform a multiplication operation utilizing a 4-bit input and an 8-bit input. The same MAC unit can also be utilized to perform a multiplication operation utilizing a first 8-bit input and a second 8-bit input.

Utilizing MAC units to perform multiplication operations with different sized inputs can allow for different artificial neural networks (ANNs) to be implemented utilizing the same MAC units. For example, a first ANN can be implemented utilizing 8-bit weights and a second ANN can be implemented utilizing 4-bit weights on the same MAC units. The second ANN can also be implemented utilizing 4-bit inputs to select 8-bit weights on the same MAC units as are used to implement the first ANN having 8-bit inputs. Utilizing the same MAC units to perform multiplication operations with different sized inputs can reduce the size of the die on which the MAC units are implemented among other savings that can be achieved as compared to implementing a first MAC unit to receive inputs of first size and a second MAC unit to receive inputs of a second size.

As used herein, selecting can describe the use of a first data value to identify a second data value. For example, the first data value can include 4 bits and the second data value includes 8 bits. The 4-bit data value can be used to identify the 8-bit data value. The 8-bit data value can be said to be selected using the 4-bit data value.

As used herein, a MAC unit describes hardware utilized to perform multiplication operations and accumulate the results of the multiplication operations. The MAC units can be implemented as part of a processing unit (PU). The PU can be hardware for perform processing operations such as multiplication operations. Although the examples provided herein are given below in terms of memory, the examples described herein can be implemented in hardware separate from memory. For example, the MAC units describe herein can be implemented in a host, a controller, a graphical processing unit (GPU), among other examples of hardware that can implement the MAC units described herein.

The inputs to the MAC units can be parts of a matrix and/or a vector. As used herein, a matrix is a grouping of data values organized into rows and columns where each data value has an order in a row and a column. For example, a first data value of a matrix can have a first index in a first row and a first index in a first column. With respect to matrix-vector multiplication, a vector is a plurality of data values organized into a single column having a number of rows (data values) equal to the quantity of columns of the matrix.

As used herein, the ANN can provide learning by forming probability weight associations between an input and an output. The probability weight associations can be provided by a plurality of nodes that comprise the ANN. The nodes together with weights, biases, and activation functions can be used to generate an output of the ANN based on the input to the ANN. A plurality of nodes of the ANN can be grouped to form layers of the ANN. The propagation of signals through an ANN utilizing weights, biases, and activation functions can implemented utilizing the MAC units. For example, the weights (e.g., first input) and forward propagation signals (e.g., second input) can be multiplied in a MAC unit using the examples described herein.

As used herein, “a number of” something can refer to one or more of such things. For example, a number of memory devices can refer to one or more memory devices. A “plurality” of something intends two or more. Additionally, designators such as “N,” as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

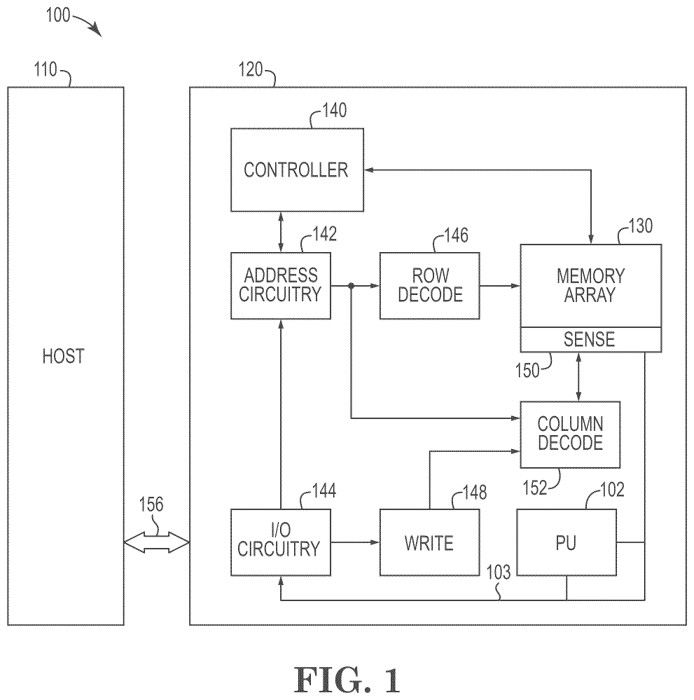

FIG. 1 is a block diagram of an apparatus in the form of a computing system 100 including a memory device 120 in accordance with a number of embodiments of the present disclosure. As used herein, a memory device 120, a memory array 130, and/or host 110 might also be separately considered an “apparatus.”

In this example, system 100 includes a host 110 coupled to memory device 120 via an interface 156. The computing system 100 can be a personal laptop computer, a desktop computer, a digital camera, a mobile telephone, a memory card reader, or an Internet-of-Things (IoT) enabled device, among various other types of systems. Host 110 can include a number of processing resources (e.g., one or more processors, microprocessors, or some other type of controlling circuitry) capable of accessing memory 120. The system 100 can include separate integrated circuits, or both the host 110 and the memory device 120 can be on the same integrated circuit. For example, the host 110 may be a system controller of a memory system comprising multiple memory devices 120, with the system controller of the host 110 providing access to the respective memory devices 120 by another processing resource such as a central processing unit (CPU).

In the example shown in FIG. 1, the host 110 is responsible for executing an operating system (OS) and/or various applications that can be loaded thereto (e.g., from memory device 120 via controller 140). The host 110 can provide access commands and/or security mode initialization commands to a memory device via the interface 156.

For clarity, the system 100 has been simplified to focus on features with particular relevance to the present disclosure. The memory array 130 can be a DRAM array, SRAM array, STT RAM array, PCRAM array, TRAM array, RRAM array, NAND flash array, and/or NOR flash array, for instance. The array 130 can comprise memory cells arranged in rows coupled by access lines (which may be referred to herein as word lines or select lines) and columns coupled by sense lines (which may be referred to herein as digit lines or data lines). Although a single array 130 is shown in FIG. 1, embodiments are not so limited. For instance, memory device 120 may include a number of arrays 130 (e.g., a number of banks of DRAM cells).

The memory device 120 includes address circuitry 142 to latch address signals provided over an interface 156. The interface can include, for example, a physical interface employing a suitable protocol (e.g., a data bus, an address bus, and a command bus, or a combined data/address/command bus). Such protocol may be custom or proprietary, or the interface 156 may employ a standardized protocol, such as Peripheral Component Interconnect Express (PCIe), Gen-Z, CCIX, or the like. Address signals are received and decoded by a row decoder 146 and a column decoder 152 to access the memory array 130. Data can be read from memory array 130 by sensing voltage and/or current changes on the sense lines using sensing circuitry 150. The sensing circuitry 150 can comprise, for example, sense amplifiers that can read and latch a page (e.g., row) of data from the memory array 130. The I/O circuitry 144 can be used for bi-directional data communication with host 110 over the interface 156. The read/write circuitry 148 is used to write data to the memory array 130 or read data from the memory array 130. As an example, the circuitry 148 can comprise various drivers, latch circuitry, etc.

Controller 140 decodes signals provided by the host 110. These signals can include chip enable signals, write enable signals, and address latch signals that are used to control operations performed on the memory array 130, including data read, data write, and data erase operations. In various embodiments, the controller 140 is responsible for executing instructions from the host 110. The controller 140 can comprise a state machine, a sequencer, and/or some other type of control circuitry, which may be implemented in the form of hardware, firmware, or software, or any combination of the three.

In various instances, the controller 140 can receive signals provided by the host 110 including signals requesting operations to be performed by a processing unit (PU) 102. For example, the controller 140 can provide a signal to the PU 102 requesting that a multiplication operation be performed. The controller 140 can receive the signal from the host 110 and can cause data to be sensed (e.g., read) from the memory array 130 and provided to the PU 102. As used herein, the PU 102 can include hardware for performing operations using data provided by the memory array 130. For example, the PU 102 can perform multiplication operations in accordance with embodiments of the present disclosure. The PU 102 can multiply a first data value (e.g., data values of a matrix or data values of a vector) with a second data value (e.g., data values of a vector). As used herein, a data value is a number that can be used to perform operations such as multiplication operations.

In various instances, the PU 102 can utilize I/O lines 103 to receive data values of the matrix and/or data values of a vector. The PU 102 can utilize the I/O lines 103 to output (e.g., provide) a result vector of data values (e.g., the result of the multiplication operations). The result vector of data values can be stored back to the memory array 130 and/or can be provided to the host 110. Utilizing the same I/O lines 103 to read data from the memory array 130, to provide data to the PU 102, and/or to provide data from the PU 102 can allow for the PU 102 to be added to the memory device 120 without substantially adding to the die area of the memory device 120. For example, the PU 102 can be added to the memory device 120 by increasing a die size of the memory device 120 by 1-3. The 1-3% increase in die size is compared to solutions in which the PU 102 is added to the memory device 120 such that the PU 102 does not receive data and/or provide data via the I/O lines 103.

In various examples, the PU 102 can receive a first quantity of data values and a second quantity of data values from the memory array 130 to perform the multiplication operation. The data values can be stored in the memory array 130 such that the data values organized in columns of a matrix can be sensed as opposed to sensing data values organized in rows of the matrix from the memory array 130.

In various instances, the controller 140 can cause data values received from the host 110 to be organized and stored in the memory array 130 such that columns of a matrix are stored in memory cells coupled to a same word line. Providing columns of data values to the PU 102 allows the PU 102 to perform operations on the columns of data values such that the results of the matrix-vector multiplication operation are stored in accumulators of the MAC units of the PU 102 without performing additional operations to combine the results into a result vector. The result vector can include data values stored in each of the MAC units. The MAC units can be read to generate the result vector without performing additional operations on the data values stored in the MAC units. Providing the result vector of the matrix-vector multiplication operation utilizing the I/O lines 103 and storing the result vector in accumulators of the MAC units of the PU 102 allows for the result vector to be generated and provided to the I/O lines 103 in the same amount of time as is used to read a single column of a memory address (e.g., 256 prefetch) worth of the matrix and/or the vector from the memory array 130.

The PU 102 can also be used to perform multiplication operations on inputs of multiple sizes (e.g., amount of bits in each input). If the PU 102 and/or the MAC units of the PU 102 are set to a first mode, a first input can be multiplied with a second input where the first input is of a first size that is different than the size of the input. For example, the first input can include 4 bits while the second input includes 8 bits. The PU 102 can divide an 8-bit input into two 4-bit inputs. Each of the 4-bit inputs can be used to perform different multiplication operations. For example, the PU 102 can receive an 8-bit word which the PU 102 can divide into two 4-bit inputs.

The PU 102 can perform a multiplication operation utilizing one of the 4-bit inputs and a second input that includes 8 bits. The PU 102 can map one of the 4-bit inputs to an 8-bit data value and multiply the 8-bit data value to the second input (e.g., second 8-bit data value). For example, the PU 102 can receive a first input that includes 4 bits and a second input that includes 8 bits. The first input can be mapped to a third input that includes 8 bits. The PU 102 can perform a multiplication operation utilizing the second input and the third input.

If the PU 102 and/or the MAC units are in a second mode, the dividing and mapping of the inputs can be bypassed. For example, a first 8-bit input can be multiplied with a second 8-bit input without dividing the inputs or mapping the inputs. The mode can be stored in a register of the memory device 120, the PU 102, and/or the MAC units. The mode can be set by, for example, the host 110. The host 110 can select whether the PU 102 is operated in a first mode or a second mode by causing an indicator of the mode to be stored in a register of the memory device 120.

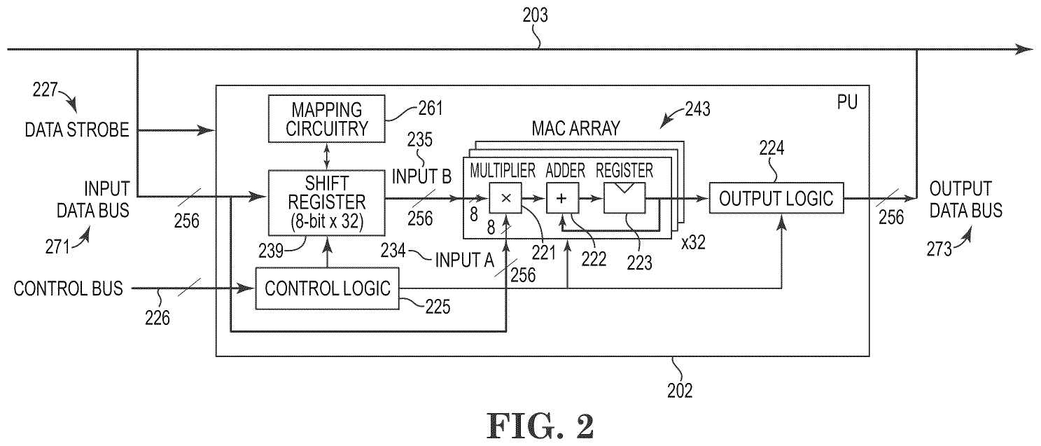

FIG. 2 is a block diagram of a PU 202 in accordance with a number of embodiments of the present disclosure. The PU 202 is coupled to the I/O lines 203. The I/O lines 203 can be coupled to the input data bus 271 and output data bus 273 for the PU 202, which can be operated according to the data strobe 227. The PU 202 includes a shift register 239, the MAC units 243, control logic 225, output logic 224, and mapping circuitry 261. The control logic 225 and/or output logic 224 can receive control signals from the controller 140 of FIG. 1 via the control bus 226, which can be coupled to the controller 140, as illustrated in FIG. 1. The PU 202 can receive signals indicative of data from the input data bus 271 and provide signals indicative of data via the output data bus 273. A given input signal from the input data bus 271 can be stored in the shift register 239 (e.g., as illustrated for input B 235) or can be provided directly to the MAC units 243 (e.g., as illustrated for input A 234), bypassing the shift register 239. The input B 235 can be provided from the shift register 239 to the MAC units 234 without requiring that the input B 235 be provided to the PU 202 multiple times.

The input signals can provide inputs (e.g., inputs 234 and 235) which represent data values from a matrix and/or a vector. Data values of a first input 235 and the data values of a second input 234 can be provided sequentially. The data values of a vector can be stored in the shift register 239. The data values of a matrix can be provided directly to the MAC units 243 or can be stored in a different register (not shown) prior to being provided to the MAC units 243. The example of FIG. 2 does not include registers to store the data values of the matrix. Other examples can include registers to store the data values of the matrix.

In the example of FIG. 2 a width of the input data bus 271 can include 256-bits. In such an example where the vectors to be operated on include 8 bits, 32 8-bit vectors can be provided in a single 256-bit chunk of data. The data values of the matrix can also be provided to the PU in 256-bit chunks. Each of the data values of the vector and the matrix can include 8 bits. The shift register 239 can provide each of the data values replicated to fill the 256 bits provided from the shift register 239 to the MAC units 243. For example, a first data value (V0) can be replicated thirty-two times to generate 256 bits. Each of the MAC units 243 can receive the 8 bits (V0) from the 256 bits.

The MAC units 243 can receive the data values of the vector from the registers 239 and the data values of the matrix from the I/O lines 203. The MAC units 243 can include multiply circuitry 221, adder circuitry 222, and output registers 223. The MAC units 243 can utilize the multiply circuitry 221, adder circuitry 222, and output registers 223 to multiply and accumulate the data values of the vector and the data values of the matrix. The output logic 224 can be controlled to output the output vector. The output vector can be provided to the I/O lines 203 via the output data bus 273.

The data strobe 227 can be utilized to provide timing signals for latching the data values in the shift register 239 and for performing the operations of the MAC units 243. The data strobe 227 can also be used to determine when to forward the output vector to the I/O lines 203.

The control signal provided via the control bus 226 can provide the control logic 225 with the information needed to perform a number of operations. For example, the control signal can be utilized to indicate to the shift register 239 that the data values should be replicated and/or shifted within the shift register 239. The control signal can cause the control logic 225 to indicate to the output logic 224 when to forward the output vector. The data strobe 227 and/or the control signal can be provided by control circuitry of the memory device.

The control signals can be used to load the shift register 239, forward (e.g., read and/or load) the output vector, and provide data values to the MAC units 243. The control signals 226 can also be used to indicate that the shift register 239 should shift data.

In various instances, the control signal 226 can include instructions for dividing the data values and/or for mapping the divided data values to different data values. In various instances, the data values can be divided and mapped while stored in the shift register 239. For example, the control logic 225 can cause data stored in the shift register 239 to be divided and provided to the mapping circuitry 261. The mapping circuitry 261 receive a portion of the data stored in the shift registers. The mapping circuitry 261 can map the received portion to different data. For example, an 8 bits of data can be divided into two 4-bit portions and one or both of the 4-bit portions can be mapped to a different 8-bit data value. The different data can be stored back to the shift register 239 by the mapping circuitry 261.

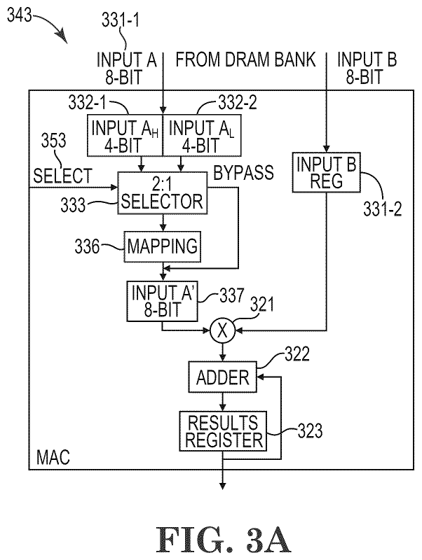

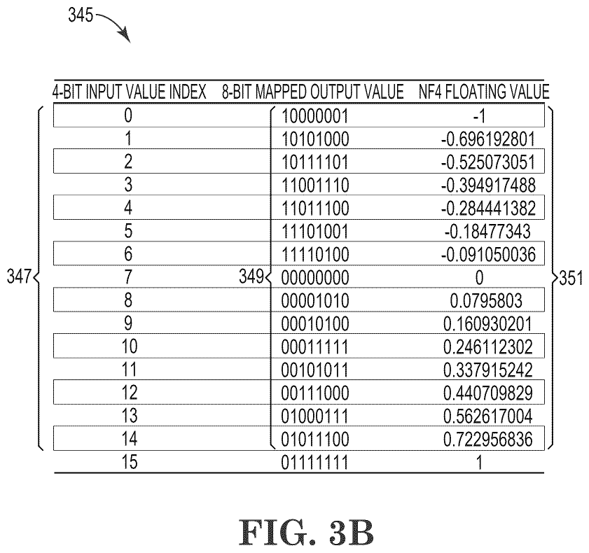

Although the control logic 225, the shift register 239, and the mapping circuitry 261 are described as dividing and mapping data to different data, different components/devices of the PU 202 can perform the dividing and the mapping. The mapping circuitry 261 can utilize a lookup table to map a first data to a second data. The lookup table can be internal to the mapping circuitry 261 or external to the mapping circuitry 261. The lookup table can be implemented as registers, SRAM, and/or a different type of memory. The mapping circuitry 261 can utilize combination logic to map the first data to the second data. The combination logic can utilize hardware to map the first data to the second data. For example, the combination logic can include a plurality of gates coupled to receive the first data and generate the second data, where the first data is shorter than the second data. Although the mapping circuitry 261 is described as being external to the MAC units 243, the mapping circuitry 261 can be internal to the MAC units 243 as described in the examples of FIG. 3A.

FIG. 3A is a block diagram of a MAC unit 343 in accordance with a number of embodiments of the present disclosure. The MAC unit 343 can receive input data 331-1 and input data 331-2. The MAC unit 343 can include selector circuitry 333 and mapping circuitry 336. The mapping circuitry 336 is shown as mapping circuitry 261 in FIG. 2. The MAC unit 343 can include multiplication circuitry 321, adder circuitry 322, and registers 323. FIG. 3B shows table 345.

The examples of FIG. 3A include the receipt of input data of a first amount. For example, the input data 331-1 can be 8 bits and the input data 331-2 can also be 8 bits. The input data 331-1 can include two data values 332-1, 332-2. The amount of each of the data values 332-1, 332-2 can be half the amount of the input 331-1. For example, the input data 331-1 can include 8 bits of data made up of a first 4-bit data value 332-1 and a second 4-bit data value 332-2.

The data values 332-1, 332-2 can be provided to the selector circuitry 333. The selector circuitry 333 can receive a selection signal 353 from the controller 140 of FIG. 1. The selection signal 353 can indicate which of the data values 332-1, 332-2 to select and/or a mode of the PU. For instance, the selection signal 353 can indicate that the PU is in a first mode. The first mode identifies that the input 331-1 is to be divided into the data values 332-1, 332-2. The selection signal 353 can provide instruction to the selection circuitry 333 identifying which of the data values 332-1, 332-2 is to be selected.

The selection circuitry 333 can select one of the data values 332-1, 332-2. Selecting one of the data values 332-1, 332-2 can include dividing (e.g., partitioning) the input 331-1 into the data values 332-1, 332-2. The selected data value can be provided to the mapping circuitry 336. The mapping circuitry 336 can map the selected data value to a third data value 337. Mapping the selected data value to the third data value 337 can include utilizing the selected data value to identify the third data value 337. The selected data value and the third data value 337 can be of different amounts. For example, the selected data value can be 4 bits while the third data value 337 is 8 bits. The third data value 337 can be double the amount of the selected data value. The third data value 337 can be of a same amount as the input 331-2. For example, both the third data value 337 and the input 331-2 can be 8 bits.

The third data value 337 and the input 331-2 can be provided to the multiplication circuitry 321. The multiplication circuitry 321 can perform one or more multiplication operations utilizing the third data value 337 and the input 331-1. The output of the multiplication circuitry 321 can be provided to the adder circuitry 332.

The adder circuitry 332 can add the output of the multiplication circuitry 321 with previous outputs of the multiplication circuitry 321. For example, the result of the adder circuitry 322 can be stored in the register 323. The value stored in the registers 323 can be provided to the adder circuitry 322. The adder circuitry 332 can perform a summation operation by adding the output of the multiplication operation 321 to the value stored in the registers 323. The output of the adder circuitry 332 can be stored in the registers 323.

In various examples, multiple multiplication operations can be performed utilizing the input 331-1. For example, a first multiplication operation can be performed utilizing the data value 332-1 and a second multiplication operation can be performed utilizing the data value 332-2.

In various instances, each of the multiplication operations can be performed utilizing the input 331-1 and the input 331-2. The multiplication operation can also be performed using one of the inputs 331-1, 331-2 and a different input. For example, the first multiplication operation can be performed utilizing the data value 332-1 and the input 331-2 while the second multiplication operation is performed utilizing the data value 332-2 and the input 331-2. The first multiplication operation can also be performed utilizing the data value 332-1 and the input 331-2 while the second multiplication operation is performed utilizing the data value 332-2 and a different input (now shown). The different input can be received by the MAC unit 343 after the input 331-2 is received.

The multiplication circuitry 321 can perform an 8-bit multiplication operation regardless of whether the PU is in a first mode or a second mode. The multiplication circuitry 321 can perform an 8-bit multiplication operation because each of the third data value 337 and the input 331-2 include 8-bits. The mapping circuitry 336 can allow the 4-bit data values 321-1, 321-2 be mapped to 8-bit data values (e.g., the data values 337). The selection circuitry 333 allows the entire input 331-1 to be utilized as the data value 337 which includes 8 bits. For example, if the MAC unit 343 is in a second mode, the mapping can be bypassed and the input 331-1 can be used, as the data value 337, to perform a multiplication operation. A single MAC unit 343 can be utilized to perform a multiplication operation using a 4-bit input and an 8-bit input or a first 8-bit input and a second 8-bit input.

Traditionally, a MAC unit would be used to perform a multiplication operation using a first 4-bit input and a second 4-bit input or a first 8-bit input and a second 8-bit input. However, implementing a MAC unit that is limited to receiving 4-bit inputs or 8-bit inputs may limit the flexibility of the MAC units to only being able to perform one of a 4-bit multiplication operation or an 8-bit multiplication operation using the 4-bit inputs or the 8-bit inputs, respectively. The examples described herein provide a single MAC unit 343 having a single multiplication circuitry 321 that can receive 4-bit inputs or 8-bit inputs for performing 8-bit multiplication operations.

FIG. 3B is a block diagram of a table 345 for mapping in accordance with a number of embodiments of the present disclosure. The mapping performed by the mapping circuitry 336 is shown in the table 345. The mapping table 345 includes a 4-bit input 347 (e.g., the data value 332-1 or the data value 332-2) and an 8-bit output 349 (e.g., data value 337). The mapping table 345 also shows the normalized float 4-bit (NF4) floating value 351 of the output 349.

The input 347 includes sixteen levels (e.g., 0, 1, . . . , 15). For example, the input 347 “0000” can be a first level (e.g., “0”). The input 347 “0001” can be a second level (e.g., “1”). The input 347 “0010” can be a third level (e.g., “3”). The input 347 “0011” can be a fourth level (e.g., “1”), etc. Utilizing a 4-bit input to perform a multiplication operation can limit the precision of the output of the multiplication operation because only sixteen levels are available for the input.

The mapping table 345 maps each of the sixteen levels of the input 347 to the outputs 349. The outputs 349 include 8 bits which allows for 256 levels. To map the inputs 347 having 16 levels to the outputs 349 having 256 levels, each of the different levels of the input 347 can be associated with one of the levels of the outputs 349. For example, the “0000” input 347 can be mapped to the “10000001” output 349.

Each of the inputs 347 can be mapped to any of the outputs 349. For example, although the input 347 “0001” (e.g., 1) is mapped to the output 349 “10101000”, the input 347 “0001” can be mapped to any level of the outputs 349, including those not shown. A controller (e.g., the control logic of FIG. 2 and/or the controller 140 of FIG. 1) can update the mapping shown in table 345 by updating the mapping circuitry 336 to reflect the updated mapping. The mapping of the input 347 to the output 349 allows for a greater accuracy in the multiplication operation and in the implementation of an ANN due to the greater number of levels of the output 349 as compared to utilizing the input 349 with fewer bits and fewer levels. The use of a 4-bit input 347 reduces the storage space utilized to perform a multiplication operation using the 8-bit output 348.

The controller can update the mapping of the inputs 347 to the outputs 349 in real time. For example, if a first ANN is being implemented by the PUs, then a first mapping can be implemented in the mapping circuitry 336. Responsive to the implementation of a second ANN, the controller can update the first mapping to a second mapping by implementing the second mapping in the mapping circuitry 336. In various examples, the mapping can be updated responsive to the PUs being in the first mode. For example, if the host places the PUs in the first mode, then the host can provide a mapping that corresponds to a first ANN to the memory device. The controller of the memory device can provide the mapping to the PUs. The PUs can store the mapping in the mapping circuitry 336 of the MAC units prior to implementing the first ANN. Responsive to implementing the first ANN and the PUs retaining the first mode, the MAC units can receive a second mapping corresponding to the second ANN prior to implementing the second ANN and after implementing the first ANN.

Although the examples described herein provide for an 8-bit input 331-1 and an 8-bit input 331-2, other examples can include inputs having greater or fewer bits than those descried herein. For example, each of the inputs 331-1 and 331-2 can be 16 bits. The 16-bit input (e.g., 332-1) can include two 8-bit data values. The selector circuitry 333 can determine whether to divide the 16-bit input or bypass the mapping circuitry 336 based on a mode of the PU. Responsive to the PU being in a first mode, the selector 333 can divide the 16-bit input into two 8-bit data values and can provide a selected data value to the mapping circuitry 336. The mapping circuitry 336 can access memory of the MAC unit 343, the PU, and/or the memory device to obtain a 16-bit output value based on the selected data value. The 16-bit output value can be provided to the multiplication circuitry 321 along with the second 16-bit input.

The multiplication circuitry 321 can perform a multiplication operation and can provide the output of the multiplication operation to the adder circuitry 322. The adder circuitry 322 can accumulate the output of the multiplication circuitry 321 with the value stored in the registers 323. The output value stored in the register 323 (e.g., output vector) can be stored in the registers 323.

In other examples, a 16-bit input can be divided to two 8-bit data values or four 4-bit data values. For example, the selection circuitry 333 can determine whether to bypass the mapping circuitry 336 or provide an 8-bit data value or a 4-bit data value to the mapping circuitry 336.

Responsive to receiving an 8-bit data value, the mapping circuitry 336 can map the 8-bit data value to a 16-bit data value which can be provided to the multiplication circuitry 321 for performance of a multiplication operation. Responsive to receiving a 4-bit data value, the mapping circuitry 336 can map the 4-bit data value to a 16-bit data value. The 16-bit data value can be provided to the multiplication circuitry 321 for performance of a multiplication operation. Using 4-bit data values or 8-bit data values to map to 16-bit data values allows for a single MAC unit to receive 4 bits, 8 bits, or 16 bits inputs and perform a multiplication operation without having to implement different MAC units and/or multiplication circuitry to perform a multiplication operation using a 4-bit data value, an 8-bit data value, or a 16-bit data value.

The mapping circuitry 336 can store and/or update different mappings corresponding to inputs of different sizes. The mapping circuitry 336 can store a first mapping for a 4-bit input (e.g., 4-bit data value) and a second mapping for an 8-bit input. The mapping circuitry 336 can receive the select signal 353. The mapping circuitry 336 can utilize the select signal 353 to determine whether to map the 4-bit input to a 16-bit output or whether to map an 8-bit input to a 16-bit output. The mapping circuitry 336 can also determine whether the received input includes 4 bits or 8 bits. Based on the determination, the mapping circuitry 336 can map a 4-bit or an 8-bit input to a 16-bit output.

If a two tiered system is used for the MAC unit where a 4-bit data value or an 8-bit data value can be mapped to a 16-bit data value, multiple modes can be utilized for the PU. For example, a first mode can indicate that the 4-bit data value can be mapped to a 16-bit data value, a second mode can indicate that the 8-bit data value can be mapped to 16-bit data value, or a third mode can indicate that the mapping is to be bypassed given that a 16-bit data value does not need to be mapped. Although an 8-bit input 331-1 and a 16-bit input is contemplated in the examples described herein, more than 16-bit inputs can be utilized. For example, a 32-bit input or a 64-bit can be divided and mapped to a 32-bit data value or a 64-bit data value, respectively.

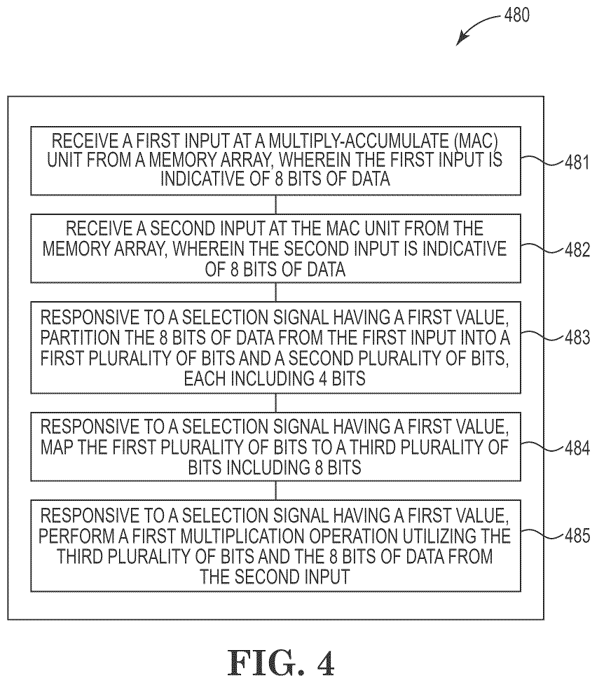

FIG. 4 illustrates an example flow diagram of a method 480 for mapping an input to a multiply-accumulate unit in accordance with a number of embodiments of the present disclosure. The method can be executed by a memory device of a computing system. For example, the method can be executed by a controller or a PU of the memory device.

At 481, a first input can be received at a MAC unit from a memory array, wherein the first input is indicative of 8 bits of data. The first input being indicative of 8 bits of data can describe that the first include is comprised of 8 bits of data. At 482, a second input can be received at the MAC unit from the memory array, where the second input is indicative of 8 bits of data. The first input and the second input can be received sequentially. The first input can include multiple data values. For example, the first input can include two data values each being indicative of 8 bits of data.

At 483, responsive to a selection signal having a first value, the 8 bits of data can be partitioned from the first input into a first plurality of bits and a second plurality of bits, each including 4 bits. The first plurality of bits can be the first data value. The second plurality of bits can be the second data value. The partitioning of the first input can include the separating of the first plurality of bits and the second plurality of bits. In various instances, the second plurality of bits can be stored in a register of the MAC unit while the first plurality of bits are being utilized to perform a first multiplication operation. The second plurality of bits can be read from the register after the first multiplication operation is performed to perform a second multiplication operation. At 484, responsive to the selection signal having the first value, the first plurality of bits can be mapped to a third plurality of bits including 8 bits. At 485, responsive to the selection signal having the first value, a first multiplication operation can be performed utilizing the third plurality of bits and the 8 bits of data from the second input. Utilizing the third plurality of bits to perform the multiplication operations allows for lossless accuracy. Lossless accuracy describes the ability to utilize 4 bits as an input but achieve the accuracy afforded using 8 bits.

Although the first plurality of bits and the second plurality of bits are described as data values. The first plurality of bits and the second plurality of bits can also function as keys. The keys can be used to access data values being mapped to including the third plurality of bits. The keys and the values being mapped to can be referred to as a database. In the context of the first plurality of bits and the second plurality of bits functioning as keys, the MAC unit can be said to include a databased used to access a plurality of data values, including the third plurality of bits, utilizing a key (e.g., the first plurality of bits). The database implemented in the MAC unit can be updated periodically to correspond to an ANN being implemented.

Responsive to the selection signal having a second value, a second multiplication operation can be performed utilizing the 8 bits of data from the first input and the 8 bits of data from the second input. The second value can indicate that the MAC unit is in a second mode. The second mode can be used to bypass the partitioning and mapping performed using the first plurality of bits. Instead, the entire 8 bits of the first input can be used to perform a multiplication operation. This allows a user and/or a host to perform multiplication operations utilizing inputs having 4 bits or 8 bits. The first value of the selection signal can indicate that the MAC unit is functioning in a first mode designed to perform multiplication operations using a 4-bit input and an 8-bit input. The second value of the selection signal can indicate that the MAC unit is functioning in a second mode designed to perform multiplication operations using a first 8-bit input and a second 8-bit input.

Responsive to the selection signal having the first value, mapping the second plurality of bits to a fourth plurality of bits. The second plurality of bits can be used to perform a second multiplication operation. Although input is divided into a first plurality of bits and a second plurality of bits, either of the first plurality of bits and the second plurality of bits can include the most significant bits of the first input or the least significant bits of the first input. Responsive to the selection signal having the first value, performing a third multiplication operation utilizing the fourth plurality of bits generated from the second plurality of bits and the 8 bits of data from the second input.

A controller of the memory device can determine whether to operate the MAC unit to perform 4-bit multiplication operations or 8-bit multiplication operations. The controller can make the determination based on instructions provided by a host coupled to the memory device. For example, the host can place the MAC units and/or the memory device in a first mode or a second mode. The controller can store the indication of the first mode or the second mode in a register. The controller can read the register prior to causing the PU to perform multiplication operations. The controller can cause inputs to be provided to the PU and/or the MAC units at different rates based on whether the memory device is in a first mode or a second mode. For example, if the memory device is in a first mode, inputs can be provided at longer intervals than if the memory device is in a second mode. For example, two different inputs can be provided to the MAC unit to perform a single multiplication operation if the MAC unit is in a second mode. Two different inputs can be provided to the MAC unit to perform two memory operations. The rate of providing input to the MAC unit can be shorter in the second mode than the first mode.

Responsive to determining to perform a 4-bit multiplication operation, the controller can provide the selection signal having the first value to the MAC unit. The multiplication operation can describe the use of a 4-bit value and an 8-bit value to perform a multiplication operation. Responsive to determining to perform an 8-bit multiplication operation, providing, via the controller, the selection signal having the second value to the MAC unit.

A first output to a first multiplication operation and a second output to the second multiplication operation can be accumulated. In examples where three or more bit values are included in the first input, the result of more than two multiplication operations can be combined to generate an output.

In various examples, a MAC unit can be coupled to an array of memory cells of a memory device. The MAC unit can receive from the array a first input indicative of first data of a first amount. The first amount can describe the quantity of bits used to represent the first data. The MAC unit can also receive from the array a second input indicative of second data of the first amount. The first data and the second data can be provided to the MAC unit separately or concurrently. The MAC unit can divide the first data into a first plurality of bits and a second plurality of bits each of a second amount. Dividing the first data and the second data allows the first data and the second data to be utilized independently. For example, the first data can be used to perform a first operation and the second data can be utilized to perform a second operation.

The MAC unit can map the first plurality of bits to a third plurality of bits of the first amount. The third plurality of bits can be of a same amount as the second input. The MAC unit can perform a multiplication operation utilizing the third plurality of bits and the second data. The multiplication can be performed because the third plurality of bits and the second plurality of bits have a same amount of bits.

The first amount can be greater than the second amount. In various instances, the second amount can be half the first amount. In other instances, the second amount can be a factor of the first amount.

A controller coupled to the MAC unit can define the mapping between the first plurality of bits and the third plurality of bits. For example, prior to performing a first multiplication operation, the controller can update a mapping to cause the first plurality of bits to be used to retrieve the third plurality of bits. Prior to performing a second multiplication operation, the controller can update the mapping to cause the first plurality of bits to be used to retrieve a fourth plurality of bits. The controller can update the mapping of multiple first different bit strings to multiple second different bit strings. As used herein, the term bit string describes a particular plurality of bits. For instance, the “0001” bits can be a first bit string. The bits “10011001” can be a different bit string. The first bit string and the second bit string can be of different amounts. The controller can map the “0001”-bit string to the “10011001”-bit string, for example. The controller can select the third plurality of bits. For example, the controller can map the “0001”-bit string to a “10010111”-bit string to perform a different multiplication operation. The controller can select the third plurality of bits based on a weight utilized in an ANN. The data values being mapped to can represent weights of an ANN. The selection of the third plurality of bits can describe that the controller can map a first plurality of bit strings to a second plurality of bit strings. The first plurality of bit strings can include the first plurality of bits, among various bit strings, and the second plurality of bit strings can include the third plurality of bits, among various different bit strings.

The MAC unit can map the first plurality of bits to the third plurality of bits utilizing a look up table. The MAC unit can map the first plurality of bits to the third plurality of bits utilizing combination logic. For example, the MAC unit can include a look up table or combination logic which can be used to map a bit string to a different bit sting. The MAC unit can update the mappings by updating the look up table or the combination logic.

The mappings may be non-linear. For example, the MAC unit can map the first plurality of bits to the third plurality of bits consistent with a non-linear mapping of a first plurality of bit-strings to a second plurality of bit-strings. The first plurality of bit-strings can include, for example, the “0001”, “0010”, “0011”, etc., bit-strings, among other possibility of bit-strings. The second plurality of bit-string can include the “00000001”, “10000000”, “00011000”, etc., bit strings.

The MAC unit can include selector circuitry configured to assign a high half of the first data to the first plurality of bits and a low half of the first data to the second plurality of bits. In other examples, the selector circuitry can also assign a low half of the first data to the plurality of bits and a high half of the data to the second plurality of bits.

In various examples, a MAC unit coupled to the first array of memory cells and to the second array of memory cells can receive a first input indicative of 16 bits of data from the first array of memory cells. The MAC unit can also receive a second input indicative of 16 bits of data from the second array of memory cells. The MAC unit can divide the 16 bits from the first input into a first plurality of bits and a second plurality of bits each including 8 bits. The MAC unit can map the first plurality of bits to a third plurality of bits including 16 bits. The MAC unit can perform a multiplication operation utilizing the third plurality of bits and the 16 bits from the second input.

The mapping of the first plurality of bit-strings to the second plurality of bit-strings can be stored in either of the first array of memory cells or the second array of memory cells prior to being provided to the MAC unit. For example, the MAC unit can receive a mapping a first plurality of bit-strings to a second plurality of bit-strings from the second array of memory cells.

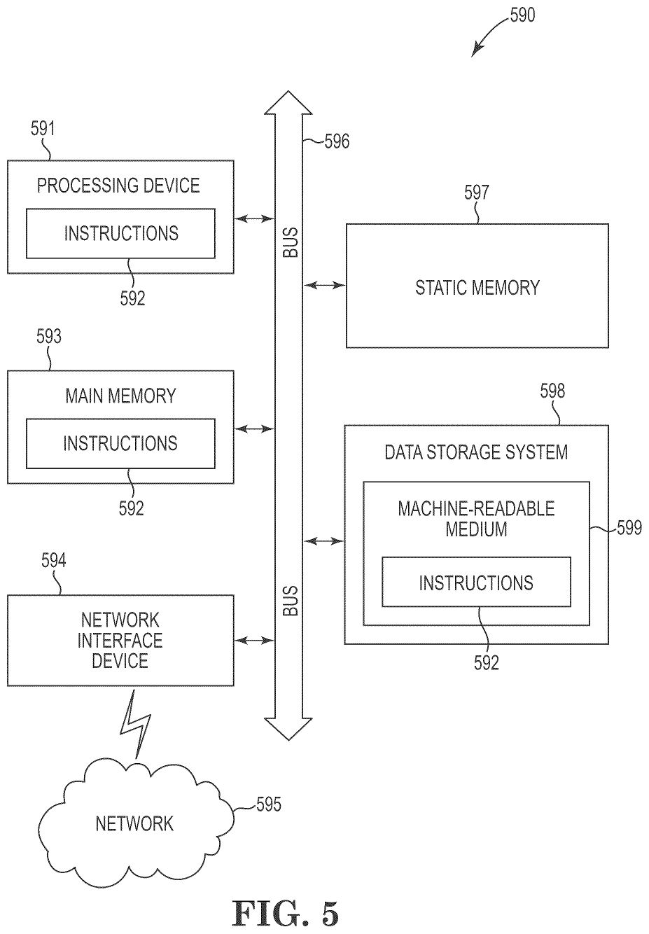

FIG. 5 illustrates an example machine of a computer system 590 within which a set of instructions, for causing the machine to perform any one or more of the methodologies discussed herein, can be executed. In some embodiments, the computer system 590 can correspond to a host system (e.g., the system 110 of FIG. 1) that includes, is coupled to, or utilizes a memory system (e.g., the memory device 120 of FIG. 1) or can be used to perform the operations of the PU (e.g., the PU 102 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 590 includes a processing device 591, a main memory 593 (e.g., read-only memory (ROM), flash memory, dynamic random access memory (DRAM) such as synchronous DRAM (SDRAM) or Rambus DRAM (RDRAM), etc.), a static memory 597 (e.g., flash memory, static random access memory (SRAM), etc.), and a data storage system 598, which communicate with each other via a bus 596.

Processing device 591 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 591 can also be one or more special-purpose processing devices such as an application specific integrated circuit (ASIC), a field programmable gate array (FPGA), a digital signal processor (DSP), network processor, or the like. The processing device 591 is configured to execute instructions 592 for performing the operations and steps discussed herein. The computer system 590 can further include a network interface device 594 to communicate over the network 595.

The data storage system 598 can include a machine-readable storage medium 599 (also known as a computer-readable medium) on which is stored one or more sets of instructions 592 or software embodying any one or more of the methodologies or functions described herein. The instructions 592 can also reside, completely or at least partially, within the main memory 593 and/or within the processing device 591 during execution thereof by the computer system 590, the main memory 593 and the processing device 591 also constituting machine-readable storage media.

In one embodiment, the instructions 592 include instructions to implement functionality corresponding to the controller 140 of FIG. 1. While the machine-readable storage medium 599 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
an array of memory cells;
a multiply-accumulate (MAC) unit coupled to the array of memory cells and configured to:
receive from the array a first input indicative of first data of a first amount;
receive from the array a second input indicative of second data of the first amount;
divide the first data into a first plurality of bits and a second plurality of bits each of a second amount;
map the first plurality of bits to a third plurality of bits of the first amount; and
perform a multiplication operation utilizing the third plurality of bits and the second data.

2. The apparatus of claim 1, wherein the first amount is greater than the second amount.

3. The apparatus of claim 1, further comprising a controller coupled to the MAC unit, wherein the controller is configured to define the mapping between the first plurality of bits and the third plurality of bits.

4. The apparatus of claim 3, wherein the controller is further configured to select the third plurality of bits.

5. The apparatus of claim 4, wherein the controller is further configured to select the third plurality of bits based on a weight utilized in an artificial neural network.

6. The apparatus of claim 1, wherein the MAC unit is configured to map the first plurality of bits to the third plurality of bits utilizing a look up table.

7. The apparatus of claim 1, wherein the MAC unit is configured to map the first plurality of bits to the third plurality of bits utilizing combination logic.

8. The apparatus of claim 1, wherein the MAC unit is configured to map the first plurality of bits to the third plurality of bits consistent with a non-linear mapping of a first plurality of bit-strings to a second plurality of bit-strings.

9. The apparatus of claim 1, wherein the MAC unit further comprises selector circuitry configured to assign a high half of the first data to the first plurality of bits.

10. The apparatus of claim 9, wherein the MAC unit further comprises selector circuitry configured to assign a low half of the first data to the first plurality of bits.

11. A method, comprising:
receiving a first input at a multiply-accumulate (MAC) unit from a memory array, wherein the first input is indicative of 8 bits of data;
receiving a second input at the MAC unit from the memory array, wherein the second input is indicative of 8 bits of data; and
responsive to a selection signal having a first value:
partitioning the 8 bits of data from the first input into a first plurality of bits and a second plurality of bits, each including 4 bits;
mapping the first plurality of bits to a third plurality of bits including 8 bits; and
performing a first multiplication operation utilizing the third plurality of bits and the 8 bits of data from the second input.

12. The method of claim 11, further comprising, responsive to the selection signal having a second value:
performing a second multiplication operation utilizing the 8 bits of data from the first input and the 8 bits of data from the second input.

13. The method of claim 11, further comprising, responsive to the selection signal having the first value, mapping the second plurality of bits to a fourth plurality of bits.

14. The method of claim 13, further comprising, responsive to the selection signal having the first value, performing a third multiplication operation utilizing the fourth plurality of bits generated from the second plurality of bits and the 8 bits of data from the second input.

15. The method of claim 11, further comprising, determining using a controller whether to operate the MAC unit to perform 4-bit multiplication operations or 8-bit multiplication operations.

16. The method of claim 15, wherein responsive to determining to perform a 4-bit multiplication operation, providing, via the controller, the selection signal having the first value to the MAC unit.

17. The method of claim 16, wherein responsive to determining to perform an 8-bit multiplication operation, providing, via the controller, the selection signal having the second value to the MAC unit.

18. The method of claim 16, further comprising accumulating a first output to a first multiplication operation and a second output to the second multiplication operation.

19. An apparatus, comprising:
a first array of memory cells;
a second array of memory cells;
a multiply-accumulate (MAC) unit coupled to the first array of memory cells and to the second array of memory cells and configured to:
receive a first input indicative of 16 bits of data from the first array of memory cells;
receive a second input indicative of 16 bits of data from the second array of memory cells;
divide the 16 bits from the first input into a first plurality of bits and a second plurality of bits each including 8 bits;
map the first plurality of bits to a third plurality of bits including 16 bits; and
perform a multiplication operation utilizing the third plurality of bits and the 16 bits from the second input.

20. The apparatus of claim 19, wherein the MAC unit is further configured to receive a mapping of a first plurality of bit-strings to a second plurality of bit-strings from the second array of memory cells.
